(19) United States
(12) Patent Application Publication
(10) Pub. No.: US 2024/0087233 A1
(43) Pub. Date: Mar. 14, 2024

(54) METHOD AND SYSTEM FOR OPTIMIZING VIRTUAL BEHAVIOR OF PARTICIPANT IN METAVERSE

(71) Applicant: SAMSUNG ELECTRONICS CO., LTD., Suwon-si (KR)

(72) Inventors: Ranjan Kumar SAMAL, Bengaluru (IN); Vivek Paul JOSEPH, Bengaluru (IN); Rajin BABU, Bengaluru (IN); Abhishek PANDEY, Bengaluru (IN); Nagaraj ADIGA, Bengaluru (IN); Somesh NANDA, Bengaluru (IN)

(73) Assignee: SAMSUNG ELECTRONICS CO., LTD., Suwon-si (KR)

(21) Appl. No.: 18/377,109

(22) Filed: Oct. 5, 2023

Related U.S. Application Data
(63) Continuation of application No. PCT/KR2023/011045, filed on Jul. 28, 2023.

(30) Foreign Application Priority Data
Sep. 12, 2022 (IN) 202241051988
Feb. 6, 2023 (IN) 202241051988

(51) Int. Cl. G06T 19/00; G06F 3/01; G06T 13/40

(52) U.S. Cl. CPC G06T 19/00; G06F 3/011; G06T 13/40; G06T 2219/004; G06T 2219/024

(57) ABSTRACT

An electronic device presents a virtual behavior of a participant in a Metaverse. The electronic device determines a context of the Metaverse including the people meeting with the participant. The electronic device determines a real-world behavior of the participant while immersed in the Metaverse. The electronic device generates virtual behavior of the participant based on the context of the Metaverse and the real-world behavior of the participant while immersed in the Metaverse. The electronic device renders an avatar of the participant having the virtual behavior of the participant.

### CROSS-REFERENCE TO RELATED APPLICATIONS

This is a continuation of International Application No. PCT/KR2023/011045, filed on Jul. 28, 2023, which is based on and claims priority from an Indian Provisional Application Number 202241051988 filed on Sep. 12, 2022, and Indian Complete Application Number 202241051988 filed on Feb. 6, 2023. The disclosures of the above applications are hereby incorporated by reference.

### BACKGROUND

### 1. Field

The present disclosure relates to an electronic device, and more specifically related to a method and a system for optimizing a virtual behavior of a participant in a Metaverse.

### 2. Description of the Related Art

Metaverse is generally regarded as a network of Three Dimensional (3D) virtual worlds where a user can interact, conduct business, and form social connections using their virtual “Avatar”. Within the Metaverse, the user can make friends, nurture virtual pets in the metaverse, design virtual fashion items, buy virtual real estate, attend events, create and sell digital art, etc. The Metaverse has suddenly become a big business where companies create their own virtual worlds or Metaverse environments. Virtual reality platforms, gaming, machine learning, blockchain, 3-D graphics, digital currencies, sensors, and (in some cases) VR-enabled headsets are all used in the Metaverse.

In existing Metaverse/electronic devices, there is a direct translation of user behavioral traits and user characteristics/oddities from a real world into a virtual world. As a result, the user's shortcomings are reflected in the virtual world as well, which is one of the drawbacks of the existing electronic device. For example, the user may exhibit behavioral traits and user characteristics/oddities such as nervousness when speaking in public (1), stuttering/stammering while speaking (2), shaky voice (3), frequent nose scratching (4), and others, as illustrated in FIG. 1. Some of the user behavioral traits and user characteristics/oddities make the user appear unconfident/nervous/anxious/weird/etc. Because of the direct translation, a majority of the user behavioral traits and user characteristics/oddities would be visible in the virtual world. The user may be dissatisfied with the direct translation and do not want others to see some of the user's behavioral traits and user characteristics/oddities, which make the user appear unconfident/nervous/anxious/weird/etc.

The existing electronic device provides a solution that allows the user to change and improve the appearance of the avatar as per requirement. Similar enhancements for the user's personality/behavioral traits/characteristics/oddities associated with the avatar are not possible in the existing electronic device. The existing electronic device does not boost the avatar's personality in the virtual world based on context. Though the existing electronic device offers avatar behavior modifications and handles user speech and action independently, the existing electronic device does so without aiming to improve specific behavioral traits.

For example, consider the user is attending a corporate meeting in a metaverse by utilizing an electronic device such as a VR-enabled headset. Behavioral traits and characteristics of the user exhibited in real world such as biting nails and stammering are applied to a virtual “Avatar” of the user in the metaverse. Then, the user may appear underconfident during the corporate meeting in the metaverse, which may not be in the best interest of the user.

Thus, it is desired to address the above-mentioned disadvantages or other shortcomings or at least provide a useful alternative for presenting an enhanced personality of the user in the Metaverse.

### SUMMARY

The principal object of the embodiments herein is to provide a method for optimizing a virtual behavior of a user in a Metaverse (virtual world). The method includes determining a Metaverse context a modal cue (e.g., audio, visual, etc.) and a real-world user behavior (e.g., behavior trait or oddity) when the user is immersed in the Metaverse. Then, the method includes categorizing the real-world user behavior as a compliant behavior or a non-compliant behavior and boosting the compliant behavior while suppressing the non-compliant behaviour. Therefore, the other Metaverse users can only see the user's optimized virtual behavior in the Metaverse, which provides a better user experience and also creates a safe environment within the Metaverse for user interaction.

### Technical Solution

Provided herein is a method for optimizing a virtual behavior of at least one participant in a Metaverse, the method including: determining, by an electronic device, at least one context of the Metaverse; identifying, by the electronic device, a real-world behavior of the at least one participant while the at least one participant is immersed in the Metaverse; generating, by the electronic device and based on the at least one context, a virtual behavior corresponding to the real-world behavior; and rendering, by the electronic device and based on the virtual behavior, an avatar of the at least one participant in the Metaverse.

Also provided herein is an electronic device for optimizing a virtual behavior of at least one participant in a Metaverse, wherein the electronic device includes: a memory; a processor; and a metaverse personality controller coupled to the memory, wherein the processor configured to: determine at least one context of the Metaverse, identify a real-world behavior of the at least one participant, generate, based on the at least one context, the virtual behavior corresponding to the real-world behavior, and render, based on the virtual behavior, an avatar of the at least one participant in the Metaverse.

In addition, embodiments herein disclose a method for optimizing a virtual behavior of a participant(s) in a Metaverse. The method includes determining, by an electronic device, a context of the Metaverse including the participant(s). Further, the method includes determining, by the electronic device, a real-world behavior of the participant(s). Further, the method includes generating, by the electronic device, the virtual behavior of the participant(s) based on the context of the Metaverse and the real-world behavior of the participant(s). Further, the method includes rendering, by the electronic device, an avatar(s) of the participant(s) having the virtual behavior of the participant(s) in the Metaverse.

In an embodiment, where determining, by the electronic device, the real-world behavior of the participant(s) includes determining, by the electronic device, a plurality of modal cues associated with the participant(s) in the Metaverse; and determining, by the electronic device, the real-world behavior of the participant(s) based on the plurality of modal cues.

In an embodiment, where generating, by the electronic device, the virtual behavior of the participant(s) based on the context of the Metaverse and the real-world behavior of the participant(s) includes detecting, by the electronic device, a non-complaint modal cue(s) from the plurality of modal cues by comparing the real-world behavior of the participant(s) and the context of the Metaverse. Further, the method includes substituting, by the electronic device, the non-compliant modal cue(s) with a compliant modal cue(s) in the plurality of modal cues. Further, the method includes generating, by the electronic device, the virtual behavior of the participant(s) having the compliant modal cue(s) for rendering in the Metaverse.

In an embodiment, the method includes detecting, by the electronic device, a real-world user action(s) of the participant in the Metaverse. Further, the method includes determining, by the electronic device, a behavioral trait(s) and/or a behavioral oddity (or oddities) of the participant(s) corresponding to the real-world user action(s). Further, the method includes determining, by the electronic device, behavioral scores corresponding to the behavioral trait(s) and/or the behavioral oddity of the participant(s). Further, the method includes retrieving, by the electronic device, optimal globally accepted behavioral scores for the behavioral trait and/or the behavioral oddity based on the context of the Metaverse, where the optimal globally accepted behavioral scores are retrieved by utilizing a global behavioral repository of the electronic device. Further, the method includes generating, by the electronic device, a corrective action(s) for the real-world user action by adjusting the behavioral trait and/or the behavioral oddity using the optimal globally accepted behavioral scores to optimize the virtual behavior of the participant(s) in the Metaverse.

In an embodiment, where determining, by the electronic device, the plurality of modal cues associated with the participant(s) in the Metaverse includes determining, by the electronic device, low-level modal information associated with the participant(s), where the low-level modal information is determined by using a modality-specific sensor(s) of the electronic device. Further, the method includes generating, by the electronic device, high-level multi-modal information based on the determined low-level modal information, where the high-level multi-modal information includes, but is not limited to, biting nails, scratching nose, worrying face expression, shaking voice, and gazing eye. Further, the method includes determining, by the electronic device, the plurality of modal cues associated with the participant(s) in the Metaverse based on the generated high-level multi-modal information.

In an embodiment, where detecting, by the electronic device, the non-complaint modal cue(s) from the plurality of modal cues by comparing the real-world behavior of the participant(s) and the context of the Metaverse includes determining, by the electronic device, delta difference scores associated with the behavioral scores and the optimal globally accepted behavioral scores. Further, the method includes determining, by the electronic device, whether the delta difference scores indicate an increment or decrement required to achieve the optimal globally accepted behavioral scores. Further, the method includes incrementing the behavioral scores in response to determining that the delta difference scores indicate the increment required to achieve the optimal globally accepted behavioral scores; or decrementing the behavioral scores in response to determining that the delta difference scores indicate the decrement required to achieve the optimal globally accepted behavioral scores. Further, the method includes assigning, by the electronic device, a modal cue score(s) based on a user defined policies and/or a modal cue(s) with greatest potential for achieving the optimal globally accepted behavioral scores. Further, the method includes detecting, by the electronic device, the non-complaint modal cue(s) from the plurality of modal cues based on the assigned modal cue score(s) and the delta difference scores.

In an embodiment, where substituting, by the electronic device, the non-compliant modal cue(s) with the compliant modal cue(s) in the plurality of modal cues indicates to perform a corrective action(s) associated with the avatar of the participant(s).

In an embodiment, where generating, by the electronic device, the corrective action(s) for the real-world user action by adjusting the behavioral trait and/or the behavioral oddity using the optimal globally accepted behavioral scores to optimize the virtual behavior of the participant(s) in the Metaverse includes determining, by the electronic device, the corrective action(s) based on a global action repository, delta difference scores, and behavioral scores corresponding to the behavioral trait and/or the behavioral oddity of the participant(s). Further, the method includes generating, by the electronic device, the corrective action(s) for the real-world user action by applying the determined corrective action(s) on the avatar of the participant(s) to optimize the virtual behavior of the participant(s) in the Metaverse.

In an embodiment, the method includes displaying, by the electronic device, a message(s) on a screen of the electronic device to perform the corrective action(s) associated with the avatar of the participant(s) in the Metaverse.

In an embodiment, where the context of the Metaverse includes a type of virtual environmental setup generated for the avatar of the user in the Metaverse, and the type of virtual environmental setup includes, but is not limited to, a public speech, a corporate meeting, a casual hangout, a social event, and a private meet.

In an embodiment, where the behavioral trait and the behavioral oddity indicate a personality of the user, and the personality includes, but is not limited to, confidence, nervousness, professionalism, normalcy, decency, joy, friendliness, and politeness.

In an embodiment, where the plurality of modal cues includes an audio cue and/or a visual cue, the audio cue includes, but is not limited to, speech fluency and a lack of speech fluency, and the visual cue includes, but are not limited to, appropriate gestures, offensive gestures, appearance, sweating, and nail-biting.

Accordingly, embodiments herein disclose the electronic device for optimizing the virtual behavior of the participant(s) in the Metaverse. The electronic device includes a Metaverse personality controller coupled with a processor and a memory. The Metaverse personality controller determines the context of the Metaverse including the participant(s). The Metaverse personality controller determines the real-world behavior of the participant(s). The Metaverse personality controller generates the virtual behavior of the participant(s) based on the context of the Metaverse and the real-world behavior of the participant(s). The Metaverse personality controller renders the avatar(s) of the participant(s) having the virtual behavior of the participant(s) in the Metaverse.

A method for optimizing a virtual behavior of a participant in a Metaverse. The method includes determining, by an electronic device, a context of the Metaverse including the participant and identifying, by the electronic device, a real-world behavior of the participant while immersed in the Metaverse. The method also includes detecting, by the electronic device, a non-complaint modal cue by comparing the real-world behavior of the participant while immersed in the Metaverse and the context of the Metaverse. Further, the method includes substituting, by the electronic device, the non-compliant modal cue with a compliant modal cue and generating, by the electronic device, the virtual behavior of the participant with the compliant modal cue in the Metaverse.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### BRIEF DESCRIPTION OF THE DRAWINGS

Embodiments are illustrated in the accompanying drawings, throughout which like reference letters indicate corresponding parts in the various figures. The embodiments herein will be better understood from the following description with reference to the drawings, in which:

FIG. 1 illustrates a problem scenario in an existing Metaverse system/electronic device, according to a prior art;

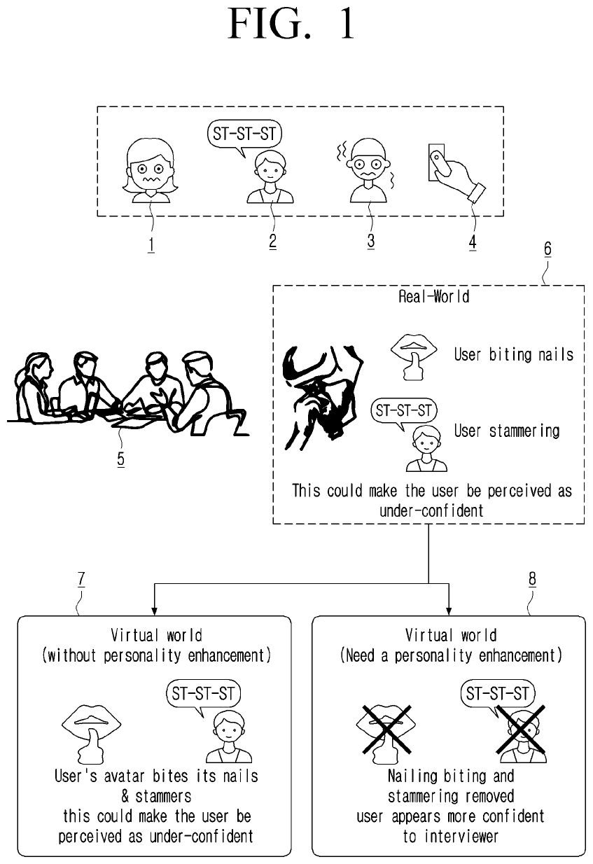

FIG. 2 illustrates a block diagram of an electronic device for enhancing a virtual behavior of a user in a Metaverse, according to an embodiment as disclosed herein;

FIG. 3 is a flow diagram illustrating a method for optimizing the virtual behavior associated with an avatar of the user in the Metaverse, according to an embodiment as disclosed herein;

FIG. 4 is an example scenario illustrating an improvement in multiple behavioral traits associated with the avatar of the user while attending an interview in the Metaverse, according to an embodiment as disclosed herein;

FIG. 5 is an example scenario illustrating an improvement in speech fluency associated with the avatar of the user in the Metaverse, according to an embodiment as disclosed herein;

FIG. 6 is an example scenario illustrating behavior training for the user in the Metaverse, according to an embodiment as disclosed herein;

FIG. 7 is an example scenario illustrating a corrective action associated with the avatar of the user to prevent misunderstandings in the Metaverse, according to an embodiment as disclosed herein; and

FIG. 8 is another example scenario illustrating a corrective action associated with the avatar of the user by detecting child-safe regions in the Metaverse, according to an embodiment as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of embodiments. Likewise, the blocks of the embodiments may be physically combined into more complex blocks without departing from the scope.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings.

Throughout this disclosure, the terms “context of the Metaverse” and “Metaverse context” are used interchangeably and mean the same.

Accordingly, embodiments herein disclose a method for optimizing a virtual behavior of a participant(s) in a Metaverse. The method includes determining, by an electronic device, a context of the Metaverse including the participant(s). Further, the method includes determining, by the electronic device, a real-world behavior of the participant(s). Further, the method includes generating, by the electronic device, the virtual behavior of the participant(s) based on the context of the Metaverse and the real-world behavior of the participant(s). Further, the method includes rendering, by the electronic device, an avatar(s) of the participant(s) having the virtual behavior of the participant(s) in the Metaverse.

Accordingly, embodiments herein disclose the electronic device for optimizing the virtual behavior of the participant(s) in the Metaverse. The electronic device includes a Metaverse personality controller coupled with a processor and a memory. The Metaverse personality controller determines the context of the Metaverse including the participant(s). The Metaverse personality controller determines the real-world behavior of the participant(s). The Metaverse personality controller generates the virtual behavior of the participant(s) based on the context of the Metaverse and the real-world behavior of the participant(s). The Metaverse personality controller renders the avatar(s) of the participant(s) having the virtual behavior of the participant(s) in the Metaverse.

In the conventional methods and systems, the behavior of the user in the real world such as biting nails which creates an underconfident impression of the user are directly projected in the metaverse. There is no mechanism to allow the user to enhance the behavioral traits preferred by the user and suppress the behavioral traits not preferred by the user. As a result, in a setup like a virtual corporate meeting the user may appear nervous and underconfident which may not be in the best interest of the user.

In the conventional methods and systems, the electronic device identifies and manages specific actions of the user. However, fine-tuning and scaling of the actions are not available. Therefore, the conventional methods and systems do not enable fine control and easy scalability with proper parameterization and mapping of the user action.

Unlike existing methods and systems, the proposed method allows the electronic device to determine the Metaverse context when the user is immersed in the Metaverse (such as the virtual corporate meeting), determine the modal cue(s) (e.g., audio, visual, etc.) associated with the user while the user is immersed in the Metaverse and determine the real-world user behavior (e.g., biting nails). Further, the electronic device categorizes the real-world user action as a compliant or a non-compliant actions for the given Metaverse context and boosts compliant actions and suppresses the non-compliant actions. As a result, other Metaverse users can only see the user's optimized virtual behavior in the Metaverse, which provides presents the user as confident and dignified for the context.

Unlike existing methods and systems, the proposed method allows the electronic device to perform a corrective action associated with an avatar of the user in the Metaverse to enhance the virtual behavior based on the metaverse context. The corrective action is based on globally accepted behavior which is complainant with the metaverse context. Therefore, the proposed method ensures that the avatar of the user is provided in the best way possible to the other users in the Metaverse.

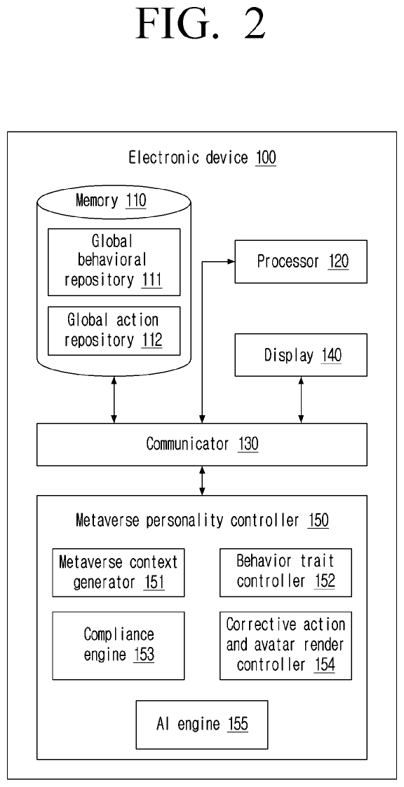

Referring now to the drawings, and more particularly to FIGS. 2 through 8, where similar reference characters denote corresponding features consistently throughout the figures, there are shown preferred embodiments.

FIG. 2 illustrates a block diagram of an electronic device (100) for enhancing a virtual behavior of a user in a Metaverse, according to an embodiment as disclosed herein. The electronic device (100) can be, for example, but not limited to a smart phone, a laptop, a desktop, a smart watch, a smart TV, Augmented Reality device (AR device), Virtual Reality device (VR device), Internet of Things (IoT) device or a like.

In an embodiment, the electronic device (100) includes a memory (110), a processor (120), a communicator (130), a display (140), and a Metaverse personality controller (150).

In an embodiment, the memory (110) stores Metaverse context (e.g., a public speech, a corporate meeting, etc.), modal cue (e.g., audio cue, visual cue, etc.) associated with the user, a behavior trait(s)/oddity of the user (e.g., confidence, professionalism, normalcy, decency, joy, friendliness, etc.), low-level modal information associated with the user while the user is immersed in the Metaverse, high-level multi-modal information (e.g., biting nails, scratching nose, worrying face expression, shaking voice, gazing eye, etc.), an optimal globally accepted behavioral scores(s), behavioral scores associated with the behavior trait/oddity of the user, a delta difference score(s), and a global action(s). The memory (110) includes a global behavioral repository (111) and a global action repository (112).

The memory (110) stores instructions to be executed by the processor (120). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in Random Access Memory (RAM) or cache). The memory (110) can be an internal storage unit or it can be an external storage unit of the electronic device (100), a cloud storage, or any other type of external storage.

The processor (120) communicates with the memory (110), the communicator (130), a display (140), and the Metaverse personality controller (150). The processor (120) is configured to execute instructions stored in the memory (110) and to perform various processes. The processor (120) may include one or a plurality of processors, maybe a general-purpose processor, such as a Central Processing Unit (CPU), an Application Processor (AP), or the like, a Graphics-only Processing Unit such as a graphics processing unit (GPU), a Visual Processing Unit (VPU), and/or an Artificial Intelligence (AI) dedicated processor such as a Neural Processing Unit (NPU).

The communicator (130) is configured for communicating internally between internal hardware components and with external devices (e.g. eNodeB, gNodeB, server, etc.) via one or more networks (e.g. Radio technology). The communicator (130) includes an electronic circuit specific to a standard that enables wired or wireless communication.

The display (140) can be a Liquid Crystal Display (LCD), a Light Emitting Diode (LED), an Organic Light-Emitting Diode (OLED), or another type of display that can also accept user inputs. Touch, swipe, drag, gesture, voice command, and other user inputs are examples of user inputs.

The Metaverse personality controller (150) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the Metaverse personality controller (150) includes a Metaverse context generator (151), a behavior trait controller (152), a compliance engine (153), a corrective action and avatar render controller (154), and an AI engine (155).

The Metaverse context generator (151) determines the context of the Metaverse including the participant(s). The context of the Metaverse includes a type of virtual environmental setup generated for an avatar of the participant(s) in the Metaverse, and the type of virtual environmental setup includes, but is not limited to, a public speech, a corporate meeting, a casual hangout, a social event, and a private meet. Furthermore, different Metaverse contexts will take up different values for the same traits. Different Metaverse contexts, e.g., Public Speech, Corporate Meetings, and Social Events. Such relational scores are learned from the participant(s). An example of the behavioral traits score is illustrated in Table I.

TABLE I

| Behavioral Traits | Public Speech | Corporate Meetings | Social Event |
|---|---|---|---|
| Confident | 0.9 | 1 | 0.5 |
| Professionalism | 0.6 | 0.95 | 0.2 |
| Normalcy | 0.8 | 0.5 | 1 |
| Decency | 0.1 | 0.6 | 1 |
| Joyful | 0.05 | 0.01 | 0.9 |
| Friendliness | 0.05 | 0.01 | 0.95 |
| Politeness | 0.7 | 0.7 | 0.95 |
| Fluency | 0.9 | 1 | 0.2 |

The behavior trait controller (152) determines the real-world behavior of the participant(s). The behavior trait controller (152) determines a plurality of modal cues associated with the participant(s) in the Metaverse. The plurality of modal cues may be based on historical knowledge. The behavior trait controller (152) determines the real-world behavior of the participant(s) based on the plurality of modal cues.

The behavior trait controller (152) determines low-level modal information associated with the participant(s). The low-level modal information is determined by using a modality-specific sensor(s). The modality-specific sensor(s) can be for example Face expression detection using camera, body posture detector, Speech disfluency detection sensor, eye gaze detector, etc. The low-level model information includes, for example, face expression, body posture, speech fluency, and direction of eye gaze. The behavior trait controller (152) generates high-level multi-modal information based on the determined low-level modal information. The high-level multi-modal information includes, but is not limited to, biting nails, scratching nose, worrying face expression, shaking voice, and gazing eye. The behavior trait controller (152) determines the plurality of modal cues associated with the participant(s) in the Metaverse based on the generated high-level multi-modal information.

The behavior trait controller (152) determines a real-world user action (e.g., talk) of the participant(s) in the Metaverse. The behavior trait controller (152) determines a behavioral trait(s) or a behavioral oddity (oddities) of the participant(s) corresponding to the real-world user action. The behavior trait controller (152) determines behavioral scores corresponding to the behavioral trait(s) or the behavioral oddity of the participant(s). The behavior trait controller (152) retrieves optimal globally accepted behavioral scores for the behavioral trait(s) and the behavioral oddity based on the context of the Metaverse. The behavioral scores can be provided for example indicating confidence, professionalism, normalcy, etc. when the context of the Metaverse is corporate virtual meeting. The behavioral scores can be provided for example indicating warmth, happiness, affection, etc. when the context of the Metaverse is for example a virtual family function. The optimal globally accepted behavioral scores are retrieved by utilizing the global behavioral repository (111) of the electronic device (100), each behavioral trait/behavioral scores are influenced by one or more modalities. The global behavioral repository (111) includes for example multiple behavioral trait accepted globally stored in the electronic device (100). For example, confident as illustrated in Table II.

TABLE II

| | | Behavioral scores | | |
|---|---|---|---|---|
| Modality/ | Modal Cues | Confident | Professionalism | Normalcy |
| Speech | Stuttering | 0.1 | 0.3 | 0.6 |
| | Filler | 0.2 | 0.5 | 0.2 |
| | Offensive | 0 | 0 | 0.4 |
| | Pitch | 0.95 | 0.8 | 0.6 |
| | Clarity | 1 | 1 | 0.8 |
| | Polite | 0.6 | 0.8 | 0.5 |
| Facial | Smiling | 0.5 | 0.5 | 0.2 |
| | Gesture | 0 | 0 | 0.1 |
| Activity | Dancing | 0 | 0 | 0.1 |
| | Running | 0 | 0 | 0.7 |
| | Sitting | 0 | 0 | 0.9 |
| Gestures | Offensive | 0 | 0 | 0.2 |
| | Hand | 0.7 | 0.8 | 0.6 |
| | Biting | 0 | 0 | 0.2 |
| | Nails | | | |

The compliance engine (153) detects a non-complaint modal cue(s) from the plurality of modal cues by comparing the real-world behavior of the participant(s) and the context of the Metaverse. The compliance engine (153) substitutes the non-compliant modal cue(s) with a compliant modal cue(s) in the plurality of modal cues. For example, when the context of the Metaverse is the virtual family function and the compliance engine (153) detects the non-complaint modal cue(s) of the user in the Metaverse such as the user sleeping then that may create a very negative impression of the user among the family members. Therefore, the non-complaint modal cue of the user sleeping may be substituted by the complaint modal cue of the user greeting the other users in the Metaverse. Substituting the non-compliant modal cue(s) with the compliant modal cue(s) in the plurality of modal cues indicates performing a corrective action(s) associated with the avatar of the participant(s).

The compliance engine (153) determines delta difference scores associated with the behavioral scores and the optimal globally accepted behavioral scores. The compliance engine (153) determines whether the delta difference scores indicate an increment or decrement required to achieve the optimal globally accepted behavioral scores. The compliance engine (153) increments the behavioral scores in response to determining that the delta difference scores indicate the increment required to achieve the optimal globally accepted behavioral scores. The compliance engine (153) decrements the behavioral scores in response to determining that the delta difference scores indicate the decrement required to achieve the optimal globally accepted behavioral scores. The compliance engine (153) assigns modal cue score(s) based on a user defined policies and a modal cue(s) with greatest potential for achieving the optimal globally accepted behavioral scores. The compliance engine (153) detects the non-complaint modal cue(s) from the plurality of modal cues based on the assigned modal cue score(s) and the delta difference scores.

The corrective action and avatar render controller (154) generates the virtual behavior of the participant(s) based on the context of the Metaverse and the real-world behavior of the participant(s). The corrective action and avatar render controller (154) renders the avatar(s) of the participant(s) having the virtual behavior of the participant(s) in the Metaverse.

The corrective action and avatar render controller (154) determines the corrective action(s) based on the global action repository (112), the delta difference scores, and the behavioral scores corresponding to the behavioral trait and/or the behavioral oddity of the participant(s). The global action repository (112) includes for example multiple complaint actions accepted globally stored in the electronic device (100). The corrective action and avatar render controller (154) generates the corrective action(s) for the real-world user action by applying the determined corrective action on the avatar(s) of the participant(s) to optimize the virtual behavior of the participant(s) in the Metaverse.

The corrective action and avatar render controller (154) displays a message(s) on a screen (i.e. display (140)) of the electronic device (100) to perform the corrective action(s) associated with the avatar(s) of the participant(s) in the Metaverse.

A function associated with the AI engine (155) may be performed through the non-volatile memory, the volatile memory, and the processor (120). One or a plurality of processors controls the processing of the input data in accordance with a predefined operating rule or AI model stored in the non-volatile memory and the volatile memory. The predefined operating rule or AI model is provided through training or learning. Here, being provided through learning means that, by applying a learning algorithm to a plurality of learning data, a predefined operating rule or AI engine (155) of the desired characteristic is made. The learning may be performed in a device itself in which AI according to an embodiment is performed, and/or may be implemented through a separate server/system. The learning algorithm is a method for training a predetermined target device (for example, a robot) using a plurality of learning data to cause, allow, or control the target device to decide or predict. Examples of learning algorithms include, but are not limited to, supervised learning, unsupervised learning, semi-supervised learning, or reinforcement learning.

The AI engine (155) may consist of a plurality of neural network layers. Each layer has a plurality of weight values and performs a layer operation through a calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

Although the FIG. 2 shows various hardware components of the electronic device (100) but it is to be understood that other embodiments are not limited thereon. In other embodiments, the electronic device (100) may include less or more number of components. Further, the labels or names of the components are used only for illustrative purpose and does not limit the scope of embodiments. One or more components can be combined to perform same or substantially similar functions to optimize the user's virtual behavioral in the Metaverse.

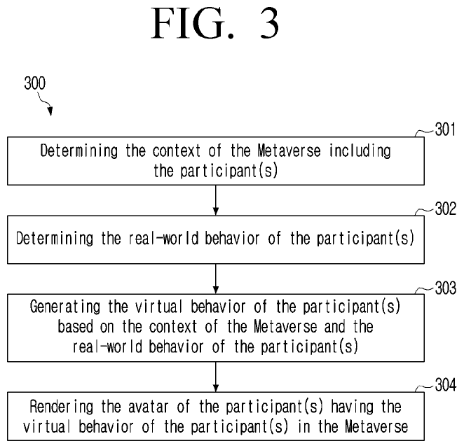

FIG. 3 is a flow diagram (300) illustrating a method for optimizing the virtual behavior associated with the avatar(s) of the user in the Metaverse, according to an embodiment as disclosed herein. The electronic device (100) performs various steps (301 to 304) to optimize the virtual behavior associated with the avatar(s) of the user in the Metaverse.

At step 301, the method includes determining the context of the Metaverse including the participant(s). At step 302, the method includes determining the real-world behavior of the participant(s). At step 303, the method includes generating the virtual behavior of the participant(s) based on the context of the Metaverse and the real-world behavior of the participant(s). At step 304, the method includes rendering the avatar of the participant(s) having the virtual behavior of the participant(s) in the Metaverse.

The various actions, acts, blocks, steps, or the like in the flow diagram (300) may be performed in the order presented, in a different order, or simultaneously. Further, in some embodiments, some of the actions, acts, blocks, steps, or the like may be omitted, added, modified, skipped, or the like without departing from the scope of the embodiments.

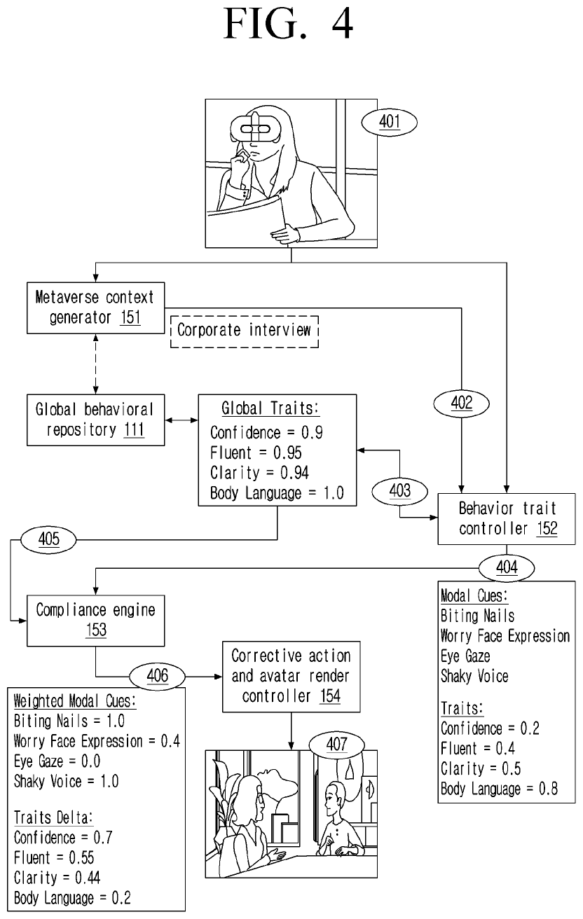

FIG. 4 is an example scenario illustrating an improvement in multiple behavioral traits associated with the avatar of the user while attending an interview in the Metaverse, according to an embodiment as disclosed herein.

In the example scenario where the user (Ileana) of the electronic device (100) is attending a job interview in the Metaverse. In the real world, she appears to be nervous. Her nervousness is visible in her odd behaviours such as nail biting, facial worry expression, eye gaze, and shaky voice. Generally, the virtual world reflects the same behaviour. However, with the implemented solution or the proposed method, her virtual character (Avatar) shows an improved boost in the confidence. A step-by-step (401-407) procedure for improving the multiple behavioral traits associated with the user's avatar is provided below.

At steps 401-402, the user/participant (Ileana) needs to attend the job interview in the Metaverse (e.g., virtual environment). Since she isn't physically present, she may be ignorant of her behavioral traits/oddity which can lead to a failed interview. To avoid that situation, the Metaverse context generator (151) determines the Metaverse context (i.e. corporate interview) of the Metaverse when the user is immersed in the Metaverse. The Metaverse context generator (151) then sends information associated with the context of the Metaverse to the behavior trait controller (152).

At steps 403-404, the behavior trait controller (152) determines the plurality of modal cues associated with the participant in the Metaverse (e.g., biting nails, worry face expression, eye gaze, shaky voice, etc.) and retrieves the optimal globally accepted behavioral scores by utilizing the global behavioral repository (111) of the electronic device (100). The optimal globally accepted behavioral scores determines based on the context of the Metaverse, as shown in Table 1.

TABLE 1

| Optimal globally accepted behavioral (trait) | Score |
|---|---|
| Confidence | 0.9 |
| Fluent | 0.95 |
| Clarity | 0.94 |
| Body language | 1.0 |

The behavior trait controller (152) determines behavioral scores related to the determined plurality of modal cues associated with the participant in the Metaverse, as shown in Table 2.

TABLE 2

| Behavioral (trait) | Score |
|---|---|
| Confidence | 0.2 |
| Fluent | 0.4 |
| Clarity | 0.5 |
| Body language | 0.8 |

The behavior trait controller (152) then sends information associated with the behavioral scores and the determined plurality of modal cues to the compliance engine (153).

At steps 405-406, the compliance engine (153) determines the delta difference scores associated with the behavioral scores and the optimal globally accepted behavioral scores, as shown in Table 3. The score values depend on the calculation method or subroutine which computes the difference between globally accepted scores and currently determined behavioral scores. The given score is just an indicative numbers.

TABLE 3

| | Optimal globally | | |
|---|---|---|---|
| Behavioral | accepted behavioral | Behavioral | Delta difference |
| (trait) | scores | scores | scores |
| Confidence | 0.9 | 0.2 | 0.7 |
| Fluent | 0.95 | 0.4 | 0.55 |
| Clarity | 0.94 | 0.5 | 0.44 |
| Body | 1.0 | 0.8 | 0.2 |
| language | | | |

The compliance engine (153) then assigns modal cue scores based on the user define policies and/or the modal cue with greatest potential for achieving the optimal globally accepted behavioral scores, as shown in Table 4.

TABLE 4

| | Weighted modal cues/ |
|---|---|
| Plurality of modal cues | assigned cue scores |
| Biting nails | 1.0 |
| Worry face expression | 0.4 |
| Eye gaze | 0.0 |
| Shaky voice | 1.0 |

The compliance engine (153) detects the non-complaint modal cue and/or the compliant modal cue from the plurality of modal cues based on the assigned modal cue scores and the delta difference scores. The compliance engine (153) then sends information associated with the assigned modal cue scores and the delta difference scores to the corrective action and avatar render controller (154).

At step-407, the compliance engine (153) completely or partially suppresses the modal cues. In the case of complete suppression, the avatar will act like an ideal person with no flaws. In the case of partial suppression, the user's natural characteristics are preserved proportionately in the avatar. The weighted modal cues in this case indicate the importance of correcting/corrective action and rendering the modal cues for improving the avatar's personality. A score of “0” indicates that optimizing the modal cue in the avatar is ignored because it may not significantly improve the avatar's personality. A score of “1” indicates the modal clues completely suppress for improving the avatar's personality.

For example, the compliance engine (153) substitutes the non-compliant modal cue(s) (e.g., worry face expression, eye gaze, etc.) with the compliant modal cue(s) (e.g., biting nails, shaky voice, etc.) in the plurality of modal cues. The compliance engine (153) then generates the virtual behavior of the participant having the compliant modal cue(s) for rendering in the Metaverse and/or the compliance engine (153) then generates the corrective action for the real-world user action by adjusting the behavioral trait and/or the behavioral oddity using the global action repository (112), the delta difference scores, the behavioral scores corresponding to the behavioral trait and/or the behavioral oddity of the participant, and the assigned modal cue scores. As a result, other Metaverse participants only see the user/participant's optimized virtual behavior in the Metaverse, which provides a better user experience.

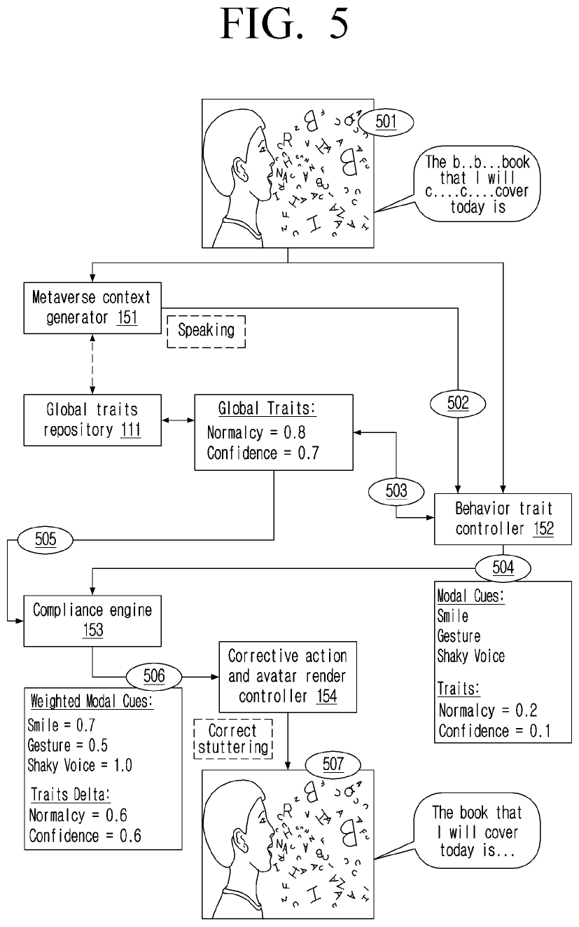

FIG. 5 is an example scenario illustrating an improvement in speech fluency associated with the avatar of the user in the Metaverse, according to an embodiment as disclosed herein.

In the example scenario where the user (John) stammers when he speaks, giving the impression that he is unconfident (even though he is confident). He has a book report due in his Metaverse classroom. He does not want his stammer to interfere with his speech, so he allows/enables the proposed method to correct speech Disfluency to be used. A step-by-step (501-507) procedure for improving the behavioral traits (speech fluency) associated with the user's avatar is provided below.

At steps 501-502, the user/participant needs to provide a speech in the Metaverse (e.g., virtual environment). Since he stammers when he speaks, giving the impression that he is unconfident. To avoid that situation, the Metaverse context generator (151) determines the Metaverse context (i.e. speaking) of the Metaverse when the user is immersed in the Metaverse. The Metaverse context generator (151) then sends information associated with the context of the Metaverse to the behavior trait controller (152).

At steps 503-504, the behavior trait controller (152) determines the plurality of modal cues associated with the participant in the Metaverse (e.g., smile, gesture, shaky voice, etc.) and retrieves the optimal globally accepted behavioral scores by utilizing the global behavioral repository (111) of the electronic device (100). The optimal globally accepted behavioral scores determines based on the context of the Metaverse, as shown in Table 5.

TABLE 5

| Optimal globally accepted behavioral (trait) | Score |
|---|---|
| Normalcy | 0.8 |
| Confidence | 0.7 |

The behavior trait controller (152) determines behavioral scores related to the determined plurality of modal cues associated with the participant in the Metaverse, as shown in Table 6.

TABLE 6

| Behavioral (trait) | Score |
|---|---|
| Normalcy | 0.2 |
| Confidence | 0.1 |

The behavior trait controller (152) then sends information associated with the behavioral scores and the determined plurality of modal cues to the compliance engine (153).

At steps 505-506, the compliance engine (153) determines the delta difference scores associated with the behavioral scores and the optimal globally accepted behavioral scores, as shown in Table 7.

TABLE 7

| | Optimal globally | | |
|---|---|---|---|
| Behavioral | accepted behavioral | Behavioral | Delta difference |
| (trait) | scores | scores | scores |
| Normalcy | 0.8 | 0.2 | 0.6 |
| Confidence | 0.7 | 0.1 | 0.6 |

The compliance engine (153) then assigns modal cue scores based on the user define policies and/or the modal cue with greatest potential for achieving the optimal globally accepted behavioral scores, as shown in Table 8.

TABLE 8

| | Weighted modal cues/ |
|---|---|
| Plurality of modal cues | assigned cue scores |
| Smile | 0.7 |
| Gesture | 0.5 |
| Shaky voice | 1.0 |

The compliance engine (153) detects the non-complaint modal cue and/or the compliant modal cue from the plurality of modal cues based on the assigned modal cue scores and the delta difference scores. The compliance engine (153) then sends information associated with the assigned modal cue scores and the delta difference scores to the corrective action and avatar render controller (154).

At step-507, the compliance engine (153) completely or partially suppresses the modal cues. In the case of complete suppression, the avatar will act like an ideal person with no flaws. In the case of partial suppression, the user's natural characteristics are preserved proportionately in the avatar. The weighted modal cues in this case indicate the importance of correcting/corrective action and rendering the modal cues for improving the avatar's personality. A score of “0.5” indicates that optimizing the modal cue in the avatar is partially ignored because it may not significantly improve the avatar's personality. A score of “1” indicates the modal clues completely suppress for improving the avatar's personality.

For example, the compliance engine (153) substitutes the non-compliant modal cue(s) (e.g., worry face expression, normalcy, decency, etc.) with the compliant modal cue(s) (e.g., shaky voice) in the plurality of modal cues. The compliance engine (153) then generates the virtual behavior of the participant having the compliant modal cue(s) for rendering in the Metaverse and/or the compliance engine (153) then generates the corrective action for the real-world user action by adjusting the behavioral trait and/or the behavioral oddity using the global action repository (112), the delta difference scores, the behavioral scores corresponding to the behavioral trait and/or the behavioral oddity of the participant, and the assigned modal cue scores. As a result, other Metaverse participants only see the user/participant's optimized virtual behavior in the Metaverse, which provides the better user experience.

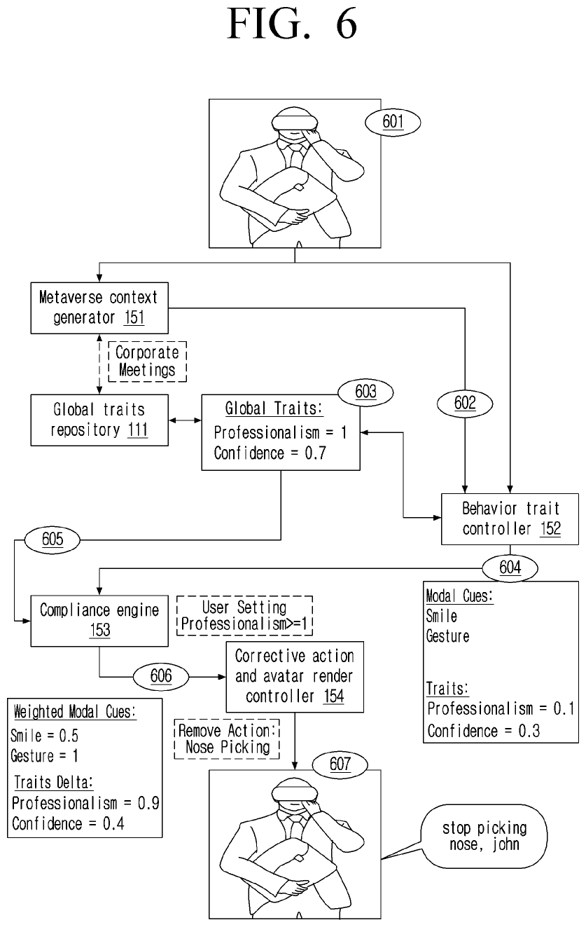

FIG. 6 is an example scenario illustrating a behavior training for the user in the Metaverse, according to an embodiment as disclosed herein.

In the example scenario where the user (John) picks his nose quite often and this makes him seem unprofessional in work related settings. Generally, the virtual world reflects the same behaviour. However, with the implemented solution/proposed method, the user removes this behavioral oddity and/or train himself for the same. A step-by-step (601-607) procedure for improving the multiple behavioral traits associated with the user's avatar is provided below.

At steps 601-602, the user/participant needs to attend the job interview in the Metaverse (e.g., virtual environment). Since she isn't physically present, he may be ignorant of her behavioral traits/oddity which can lead to a failed interview. To avoid that situation, the Metaverse context generator (151) determines the Metaverse context (i.e. corporate interview) of the Metaverse when the user is immersed in the Metaverse. The Metaverse context generator (151) then sends information associated with the context of the Metaverse to the behavior trait controller (152).

At steps 603-604, the behavior trait controller (152) determines the plurality of modal cues associated with the participant in the Metaverse (e.g., biting nails, worry face expression, eye gaze, shaky voice, etc.) and retrieves the optimal globally accepted behavioral scores by utilizing the global behavioral repository (111) of the electronic device (100). The optimal globally accepted behavioral scores determines based on the context of the Metaverse, as shown in Table 9.

TABLE 9

| Optimal globally accepted behavioral (trait) | Score |
|---|---|
| Professionalism | 1 |
| Confidence | 0.7 |

The behavior trait controller (152) determines behavioral scores related to the determined plurality of modal cues associated with the participant in the Metaverse, as shown in Table 10.

TABLE 10

| Behavioral (trait) | Score |
|---|---|
| Professionalism | 0.1 |
| Confidence | 0.3 |

The behavior trait controller (152) then sends information associated with the behavioral scores and the determined plurality of modal cues to the compliance engine (153).

At steps 605-606, the compliance engine (153) determines the delta difference scores associated with the behavioral scores and the optimal globally accepted behavioral scores, as shown in Table 11.

TABLE 11

| | Optimal globally | | |
|---|---|---|---|
| Behavioral | accepted behavioral | Behavioral | Delta difference |
| (trait) | scores | scores | scores |
| Professionalism | 1 | 0.1 | 0.9 |
| Confidence | 0.7 | 0.3 | 0.4 |

The compliance engine (153) then assigns modal cue scores based on the user define policies and/or the modal cue with greatest potential for achieving the optimal globally accepted behavioral scores, as shown in Table 12.

TABLE 12

| | Weighted modal cues/ |
|---|---|
| Plurality of modal cues | assigned cue scores |
| Smile | 0.5 |
| Gesture (nose picking | 1 |
| while talking) | |

The compliance engine (153) detects the non-complaint modal cue and/or the compliant modal cue from the plurality of modal cues based on the assigned modal cue scores and the delta difference scores. The compliance engine (153) then sends information associated with the assigned modal cue scores and the delta difference scores to the corrective action and avatar render controller (154).

At step-607, the compliance engine (153) completely or partially suppresses the modal cues. In the case of complete suppression, the avatar will act like an ideal person with no flaws. In the case of partial suppression, the user's natural characteristics are preserved proportionately in the avatar. The weighted modal cues in this case indicate the importance of correcting/corrective action and rendering the modal cues for improving the avatar's personality. A score of “0.5” indicates that optimizing the modal cue in the avatar is partially ignored because it may not significantly improve the avatar's personality. A score of “1” indicates the modal clues completely suppress for improving the avatar's personality.

For example, the compliance engine (153) substitutes the non-compliant modal cue(s) (e.g., smile) with the compliant modal cue(s) (e.g., gesture) in the plurality of modal cues. The compliance engine (153) then generates the virtual behavior of the participant having the compliant modal cue(s) for rendering in the Metaverse and/or the compliance engine (153) then generates the corrective action for the real-world user action by adjusting the behavioral trait and/or the behavioral oddity using the global action repository (112), the delta difference scores, the behavioral scores corresponding to the behavioral trait and/or the behavioral oddity of the participant, and the assigned modal cue scores. As a result, other Metaverse participants only see the user/participant's optimized virtual behavior in the Metaverse, which provides a better user experience.

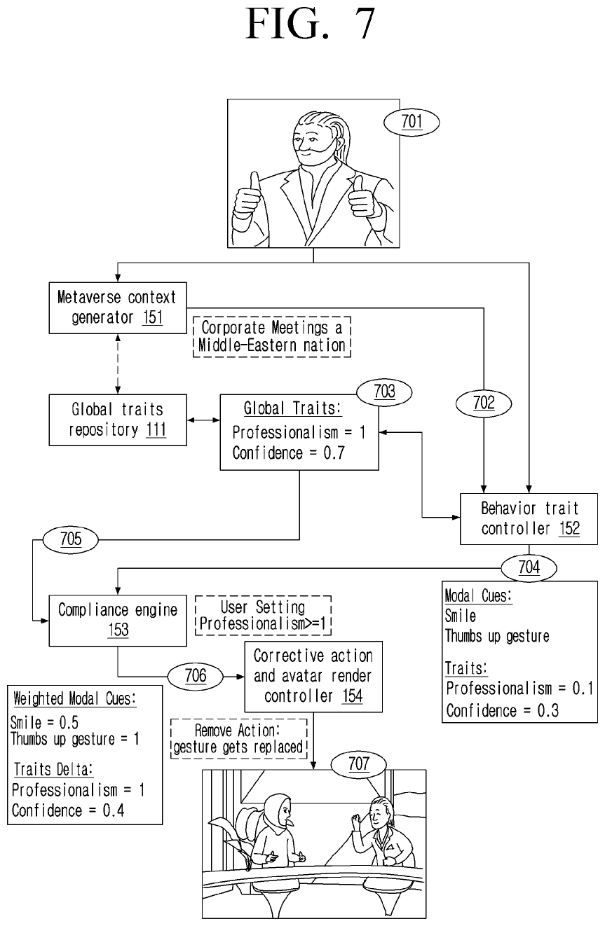

FIG. 7 is an example scenario illustrating a corrective action associated with the avatar of the user to prevent misunderstandings in the Metaverse, according to an embodiment as disclosed herein.

As the Metaverse has people from all over the world interacting with each other, blanket rules for what is considered offensive may not be feasible. For example, the user (Sam) is in a Metaverse work environment with diverse set of co-workers from all parts of world, Sam is speaking to a colleague who is from a Middle-Eastern nation where thumbs up gesture is considered offensive. A step-by-step (701-707) procedure for correcting action associated with the avatar of the user to prevent misunderstandings in the Metaverse provided below. The corrective actions applied can be visible to one or more person. For example if the group contains one middle-eastern and rest all are western, the corrective action will only be visible to middle-eastern person. All other people for whom the action may not be offensive will see the original traits.

At steps 701-702, the user/participant needs to attend the job interview in the Metaverse (e.g., virtual environment). Since he isn't physically present, he may be ignorant of her behavioral traits/oddity which can lead to misunderstandings. To avoid that situation, the Metaverse context generator (151) determines the Metaverse context (i.e. corporate meeting with Middle Eastern nation) of the Metaverse when the user is immersed in the Metaverse. The Metaverse context generator (151) then sends information associated with the context of the Metaverse to the behavior trait controller (152).

At steps 703-704, the behavior trait controller (152) determines the plurality of modal cues associated with the participant in the Metaverse (e.g., smile, thumbs up gesture, etc.) and retrieves the optimal globally accepted behavioral scores by utilizing the global behavioral repository (111) of the electronic device (100). The optimal globally accepted behavioral scores determines based on the context of the Metaverse, as shown in Table 13.

TABLE 13

| Optimal globally accepted behavioral (trait) | Score |
|---|---|
| Professionalism | 1 |
| Confidence | 0.7 |

The behavior trait controller (152) determines behavioral scores related to the determined plurality of modal cues associated with the participant in the Metaverse, as shown in Table 14.

TABLE 14

| Behavioral (trait) | Score |
|---|---|
| Professionalism | 0.1 |
| Confidence | 0.3 |

The behavior trait controller (152) then sends information associated with the behavioral scores and the determined plurality of modal cues to the compliance engine (153).

At steps 705-706, the compliance engine (153) determines the delta difference scores associated with the behavioral scores and the optimal globally accepted behavioral scores, as shown in Table 15.

TABLE 15

| | Optimal globally | | |
|---|---|---|---|
| Behavioral | accepted behavioral | Behavioral | Delta difference |
| (trait) | scores | scores | scores |
| Professionalism | 1 | 0.1 | 0.9 |
| Confidence | 0.7 | 0.3 | 0.4 |

The compliance engine (153) then assigns modal cue scores based on the user define policies and/or the modal cue with greatest potential for achieving the optimal globally accepted behavioral scores, as shown in Table 16.

TABLE 16

| | Weighted modal cues/ |
|---|---|
| Plurality of modal cues | assigned cue scores |
| Smile | 0.5 |
| Thumbs up gesture | 1 |

The compliance engine (153) detects the non-complaint modal cue and/or the compliant modal cue from the plurality of modal cues based on the assigned modal cue scores and the delta difference scores. The compliance engine (153) then sends information associated with the assigned modal cue scores and the delta difference scores to the corrective action and avatar render controller (154).

At step-707, the compliance engine (153) completely or partially suppresses the modal cues. In the case of complete suppression, the avatar will act like an ideal person with no flaws. In the case of partial suppression, the user's natural characteristics are preserved proportionately in the avatar. The weighted modal cues in this case indicate the importance of correcting/corrective action and rendering the modal cues for improving the avatar's personality. A score of “0.5” indicates that optimizing the modal cue in the avatar is partially ignored because it may not significantly improve the avatar's personality. A score of “1” indicates the modal clues completely suppress for improving the avatar's personality. The globally accepted behavioral scores can be of any popular persons such as Actor, Entrepreneur, etc. In case of complete suppression, the Avatar is ideally mimicking the person for which the behavior scores are present in DB. Moreover the globally accepted scores are learnt from variety of popular people popular in the context. For example Elon Musk, Jeff Bezos is popular as an entrepreneur. Hence the globally accepted behavioral traits are average trait score of these people.

For example, the compliance engine (153) substitutes the non-compliant modal cue(s) (e.g., smile) with the compliant modal cue(s) (e.g., Thumbs up gesture) in the plurality of modal cues. The compliance engine (153) then generates the virtual behavior of the participant having the compliant modal cue(s) for rendering in the Metaverse and/or the compliance engine (153) then generates the corrective action for the real-world user action by adjusting the behavioral trait and/or the behavioral oddity using the global action repository (112), the delta difference scores, the behavioral scores corresponding to the behavioral trait and/or the behavioral oddity of the participant, and the assigned modal cue scores. As a result, other Metaverse participants only see the user/participant's optimized virtual behavior in the Metaverse, which provides a better user experience. The compliant cues can as well be the negative behavioral traits if the situation demands. For example, if the user wants to mingle with a social group in a social setup, we may want to boost the usage of offensive words based on the group interactions.

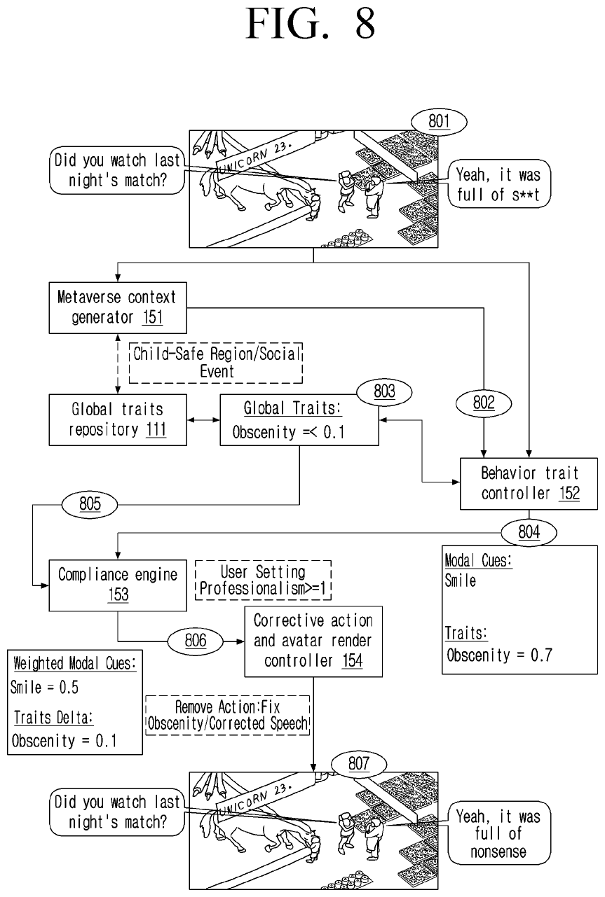

FIG. 8 is another example scenario illustrating a corrective action associated with the avatar of the user by detecting child-safe regions in the Metaverse, according to an embodiment as disclosed herein.

In the example scenario where the user utilizes/enables child-safe regions in the Metaverse. For example, the user (John) and Gina are with their nephew at a ‘Child-Safe’ Metaverse store. What were they talking about last night's game and the user says something offensive/bad, swears and forgets that his nephew is nearby. During that time, the proposed method/electronic device (100), which detects obscenity in language, is fixed and child-safe. A step-by-step (801-807) procedure for correcting action associated with the avatar of the user in the Metaverse provided below.

At steps 801-802, the user/participant talking about last night's game with his friend and the user says something offensive/bad, swears and forgets that his nephew is nearby. To avoid that situation, the Metaverse context generator (151) determines the Metaverse context (i.e. corporate interview) of the Metaverse when the user is immersed in the Metaverse. The Metaverse context generator (151) then sends information associated with the context of the Metaverse to the behavior trait controller (152).

At steps 803-804, the behavior trait controller (152) determines the plurality of modal cues associated with the participant in the Metaverse (e.g., smile) and retrieves the optimal globally accepted behavioral scores by utilizing the global behavioral repository (111) of the electronic device (100). The optimal globally accepted behavioral scores determines based on the context of the Metaverse, as shown in Table 17. The optimal globally accepted behavioral score may also be referred to as a predetermined score.

TABLE 17

| Optimal globally accepted behavioral (trait) | Score |
|---|---|
| Obscenity | 0.1 |

The behavior trait controller (152) determines behavioral scores related to the determined plurality of modal cues associated with the participant in the Metaverse, as shown in Table 18.

TABLE 18

| Behavioral (trait) | Score |
|---|---|
| Obscenity | 0.7 |

The behavior trait controller (152) then sends information associated with the behavioral scores and the determined plurality of modal cues to the compliance engine (153).

At steps 805-806, the compliance engine (153) determines the delta difference scores associated with the behavioral scores and the optimal globally accepted behavioral scores, as shown in Table 19. To distinguish from the predetermined score (optimal globally accepted behavioral scores), the score associated with the participant and their avatar may be referred to as a first score.

TABLE 19

| | Optimal globally | | |
|---|---|---|---|
| Behavioral | accepted behavioral | Behavioral | Delta difference |
| (trait) | scores | scores | scores |
| Obscenity | 0.1 | 0.7 | 0.1 |

The compliance engine (153) then assigns modal cue scores based on the user define policies and/or the modal cue with greatest potential for achieving the optimal globally accepted behavioral scores, as shown in Table 20.

TABLE 20

| | Weighted modal cues/ |
|---|---|
| Plurality of modal cues | assigned cue scores |
| Smile | 0.5 |

The compliance engine (153) detects the non-complaint modal cue and/or the compliant modal cue from the plurality of modal cues based on the assigned modal cue scores and the delta difference scores. The compliance engine (153) then sends information associated with the assigned modal cue scores and the delta difference scores to the corrective action and avatar render controller (154).

At step-807, the compliance engine (153) completely or partially suppresses the modal cues. In the case of complete suppression, the avatar will act like an ideal person with no flaws. In the case of partial suppression, the user's natural characteristics are preserved proportionately in the avatar. The weighted modal cues in this case indicate the importance of correcting/corrective action and rendering the modal cues for improving the avatar's personality. A score of “0” indicates that optimizing the modal cue in the avatar is ignored because it may not significantly improve the avatar's personality. A score of “1” indicates the modal clues completely suppress for improving the avatar's personality.

For example, in FIG. 8 a first person is using a first augmented reality (AR) device and the avatar is visible on a second AR device worn by a second person. Rendering the avatar includes sending a digital representation of the avatar to the second person meeting with the first person, the avatar is displayed on the second AR device. In 801, the first person has used unacceptable language (or gesture) and the avatar has been modified to avoid this language (or gesture). In some embodiments (not shown) the first person receives a message on their screen and may make adjustments based on this feedback. Embodiments then generate a second avatar based on the first person's response to the message, and a second avatar is generated and sent to the second person.

For example, the compliance engine (153) substitutes the non-compliant modal cue(s) (e.g., smile) with the compliant modal cue(s) in the plurality of modal cues. The compliance engine (153) then generates the virtual behavior of the participant having the compliant modal cue(s) for rendering in the Metaverse and/or the compliance engine (153) then generates the corrective action for the real-world user action by adjusting the behavioral trait and/or the behavioral oddity using the global action repository (112), the delta difference scores, the behavioral scores corresponding to the behavioral trait and/or the behavioral oddity of the participant, and the assigned modal cue scores. As a result, other Metaverse participants only see the user/participant's optimized virtual behavior in the Metaverse, which provides a better user experience.

In the virtual world, the existing Metaverse/electronic device eliminates or replaces the user's offensive words, filler words, and phrases. The existing Metaverse/electronic device also modifies independent speech parameters like rate of speech, pitch, and so on. However, the existing Metaverse/electronic device performs such processing regardless of the virtual world's situational context. While the proposed method/electronic device (100) eliminates/replaces/boosts speech parameters/filler words/offensive words or phrases based on the Metaverse context. For example, a user who uses some offensive word casually among close friends does not need it suppressed. However, in a corporate environment, the same must be avoided, which is managed by the proposed method/electronic device (100).

Furthermore, the proposed method/electronic device (100) alters multiple modalities simultaneously to boost the virtual behavior/personality of the user. For example, in a corporate interview, the proposed method/electronic device (100) eliminates nervousness by suppressing shaky voice, and nail-biting body behavior. Furthermore, the proposed method/electronic device (100). Furthermore, the proposed method/electronic device (100) controls different behavioral traits simultaneously. For example, in a public speech, in addition to bringing confidence to the user via an un-shaky voice, the proposed method/electronic device (100) improves body language by suppressing the non-compliant actions and boosting the compliant actions.

The application particularly discloses a method and device for digital signal processing. The digital signal processing is in the form of generating an avatar. The avatar is an interface between a participant in the Metaverse and other people they are meeting with. The avatar is in a Metaverse. Based on an electronic device generating the avatar and transmitting it, the avatar may be visible by means of an AR device worn by a second person. The transmission may be performed wiredly or wirelessly. Embodiments improve the interface and also, as an example, may provide a message to the participant concerning a corrective action which is occurring with their avatar. Based on the message, the participant may modify their physical behavior such as speech or gestures, which will in turn be processed by the digital signal processing and this will update the avatar seen by the second person.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method for optimizing a virtual behavior of at least one participant in a Metaverse, the method comprising:
determining, by an electronic device, at least one context of the Metaverse;
identifying, by the electronic device, a real-world behavior of the at least one participant while the at least one participant is immersed in the Metaverse;
generating, by the electronic device and based on the at least one context, a virtual behavior corresponding to the real-world behavior; and
rendering, by the electronic device and based on the virtual behavior, an avatar of the at least one participant in the Metaverse.

2. The method of claim 1, wherein the determining the real-world behavior comprises:
determining, by the electronic device, a plurality of modal cues, wherein the plurality of modal cues are associated with the at least one participant; and
determining, by the electronic device and based on the plurality of modal cues, the real-world behavior of the at least one participant.

3. The method of claim 2, wherein the generating the virtual behavior comprises:
detecting, by the electronic device, at least one non-compliant modal cue among the plurality of modal cues by comparing the real-world behavior and the at least one context;
substituting, by the electronic device, the at least one non-compliant modal cue with at least one compliant modal cue; and
generating, by the electronic device, the virtual behavior, wherein the virtual behavior comprises the at least one compliant modal cue.

4. The method of claim 1 further comprising:
detecting, by the electronic device, at least one real-world user action of the at least one participant;
determining, by the electronic device, at least one of a behavioral trait or a behavioral oddity corresponding to the at least one real-world user action;
determining, by the electronic device, first behavioral scores corresponding to at least one of the behavioral trait and the behavioral oddity of the at least one participant;
retrieving, by the electronic device from a global behavioral repository of the electronic device, predetermined behavioral scores for at least one of the behavioral trait and the behavioral oddity based on the at least one context; and
generating, by the electronic device, at least one corrective action for the at least one real-world user action by adjusting at least one of the behavioral trait or the behavioral oddity using the predetermined behavioral scores.

5. The method of claim 2, wherein the determining the plurality of modal cues comprises:
determining, by the electronic device using at least one modality-specific sensor, low-level modal information associated with the at least one participant;
generating, by the electronic device based on the low-level modal information, high-level multi-modal information; and
determining, by the electronic device and based on the high-level multi-modal information, the plurality of modal cues associated with the at least one participant.

6. The method of claim 3, wherein the detecting the at least one non-compliant modal cue comprises:
determining, by the electronic device, delta difference scores associated with behavioral scores and predetermined behavioral scores;
determining, by the electronic device, whether the delta difference scores indicate an increment or a decrement is required to achieve the predetermined behavioral scores;
performing, by the electronic device, one of:
incrementing the behavioral scores in response to determining that the delta difference scores indicate the increment is required, or
decrementing the behavioral scores in response to determining that the delta difference scores indicate the decrement is required;
assigning, by the electronic device, at least one modal cue score based on a user defined policy and a modal cue with greatest potential for achieving the predetermined behavioral scores; and
detecting, by the electronic device based on the at least one modal cue score and the delta difference scores, the at least one non-compliant modal cue.

7. The method of claim 3, wherein the substituting corresponds to performing at least one corrective action associated with the avatar.

8. The method of claim 4, wherein the generating, by the electronic device, the at least one corrective action comprises determining, by the electronic device, the at least one corrective action based on at least one of a global action repository, delta difference scores, and the first behavioral scores, and
wherein the generating the at least one corrective action comprises applying the at least one corrective action on the avatar.

9. The method of claim 1, wherein the method comprises displaying, by the electronic device, at least one message on a screen of the electronic device, wherein the at least one message is configured to indicate at least one corrective action associated with the avatar.

10. The method of claim 1, wherein the at least one context of the Metaverse includes a type of virtual environmental setup generated for the avatar, and the type of virtual environmental setup comprises at least one of a public speech, a corporate meeting, a casual hangout, a social event, and a private meeting.

11. The method of claim 4, wherein at least one of the behavioral trait or the behavioral oddity indicates a personality of the at least one participant, and the personality comprises at least one of confidence, nervousness, professionalism, amateurism, normalcy, decency, joy, friendliness, and politeness.

12. The method of claim 2, wherein the plurality of modal cues comprises at least one of an audio cue and a visual cue.

13. An electronic device for optimizing a virtual behavior of at least one participant in a Metaverse, wherein the electronic device comprises:
a memory;
a processor; and
a metaverse personality controller coupled to the memory,
wherein the processor configured to:
determine at least one context of the Metaverse,
identify a real-world behavior of the at least one participant,
generate, based on the at least one context, the virtual behavior corresponding to the real-world behavior, and
render, based on the virtual behavior, an avatar of the at least one participant in the Metaverse.

14. The electronic device of claim 13, wherein the processor is further configured to:
detect at least one non-compliant modal cue of a plurality of modal cues by comparing the real-world behavior and the at least one context;
substitute the at least one non-compliant modal cue with at least one compliant modal cue; and
generate the virtual behavior with the at least one compliant modal cue.

15. The electronic device of claim 14, wherein the processor is further configured to render the avatar of the at least one participant using the virtual behavior.

16. The method of claim 1, wherein the at least one participant is using a first augmented reality (AR) device and the avatar is visible on a second AR device.

17. The method of claim 16, wherein the rendering the avatar comprises sending a digital representation of the avatar to a second person meeting with the at least one participant for display on the second AR device.

18. The method of claim 17, further comprising displaying a message on the first AR device as feedback for the at least one participant to modify a speech or a gesture.

19. The method of claim 18, further comprising generating a second avatar based on the at least one participant modifying their speech or behavior in response to the message.

20. The method of claim 19, further comprising sending a second digital representation of the second avatar to the second person.
